(19) United States
(12) Patent Application Publication
(10) Pub. No.: US 2023/0378434 A1
(43) Pub. Date: Nov. 23, 2023

(54) SECONDARY BATTERY

(71) Applicant: MURATA MANUFACTURING CO., LTD., Kyoto (JP)

(72) Inventor: Nidhi JAIN, Kyoto (JP)

(21) Appl. No.: 18/228,264

(22) Filed: Jul. 31, 2023

Related U.S. Application Data
(63) Continuation of application No. PCT/JP2022/007292, filed on Feb. 22, 2022.

(30) Foreign Application Priority Data
Mar. 19, 2021 (JP) 2021-046520

(51) Int. Cl. H01M 4/131; H01M 4/36; H01M 4/62; H01M 10/0567; H01M 10/0568; H01M 4/525; H01M 50/105; H01M 50/136; H01M 10/0525; H01M 10/42

(52) U.S. Cl. CPC H01M 4/131; H01M 4/366; H01M 4/62; H01M 10/0567; H01M 10/0568; H01M 4/525; H01M 50/105; H01M 50/136; H01M 10/0525; H01M 10/4235; H01M 2004/028

(57) ABSTRACT

A secondary battery includes a positive electrode, a negative electrode, and an electrolytic solution. The positive electrode includes a positive electrode active material layer and a film. The film covers a surface of the positive electrode active material layer. The film includes cobalt, carbon, nitrogen, boron, and oxygen. A first peak derived from CoC₂N₂⁻ and a second peak derived from BOₓ⁻ are detectable based on a negative ion analysis of the film by time-of-flight secondary ion mass spectrometry. A ratio of an intensity of the second peak to an intensity of the first peak is greater than or equal to 0.19 and less than or equal to 1.00.

### CROSS SECTION TO RELATED APPLICATIONS

The present application is a continuation of PCT patent application no. PCT/JP2022/007292, filed on Feb. 22, 2022, which claims priority to Japanese patent application no. 2021-046520, filed on Mar. 19, 2021, the entire contents of which are incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolytic solution. A configuration of the secondary battery has been considered in various ways.

Specifically, in order to suppress swelling of a secondary battery during storage at high temperature, an aliphatic dinitrile compound is included in a non-aqueous electrolytic solution. In order to improve performance at high temperature, a film including an aliphatic dinitrile compound is formed on a surface of an electrode. In order to suppress swelling of a secondary battery, lithium tetrafluoroborate and succinonitrile are included in an electrolytic solution.

### SUMMARY

The present technology relates to a secondary battery.

Although consideration has been given in various ways regarding a battery characteristic of a secondary battery, the secondary battery still remains insufficient in a battery capacity characteristic, a swelling characteristic, and an electric resistance characteristic. Accordingly, there is room for improvement in terms thereof.

It is therefore desirable to provide a secondary battery that makes it possible to achieve a superior battery capacity characteristic, a superior swelling characteristic, and a superior electric resistance characteristic.

A secondary battery according to an embodiment of the present technology includes a positive electrode, a negative electrode, and an electrolytic solution. The positive electrode includes a positive electrode active material layer and a film. The film covers a surface of the positive electrode active material layer. The film includes cobalt, carbon, nitrogen, boron, and oxygen. A first peak derived from CoC₂N₂⁻ and a second peak derived from BOₓ⁻ are detectable based on a negative ion analysis of the film by time-of-flight secondary ion mass spectrometry. A ratio of an intensity of the second peak to an intensity of the first peak is greater than or equal to 0.19 and less than or equal to 1.00.

According to the secondary battery of an embodiment, the positive electrode includes the positive electrode active material layer and the film, and the film includes cobalt, carbon, nitrogen, boron, and oxygen as constituent elements. Based on the negative ion analysis of the film by time-of-flight secondary ion mass spectrometry, the first peak derived from CoC₂N₂⁻ and the second peak derived from BOₓ⁻ are detectable, and the ratio of the intensity of the second peak to the intensity of the first peak is greater than or equal to 0.19 and less than or equal to 1.00. Accordingly, it is possible to achieve a superior battery capacity characteristic, a superior swelling characteristic, and a superior electric resistance characteristic according to an embodiment.

Note that effects of the present technology are not necessarily limited to those described herein and may include any of a series of suitable effects in relation to the present technology.

### BRIEF DESCRIPTION OF THE FIGURES

FIG. 1 is a perspective view of a configuration of a secondary battery according to an embodiment of the present technology.

FIG. 2 is a sectional view of a configuration of a battery device illustrated in FIG. 1.

FIG. 3 is a block diagram illustrating a configuration of an application example of the secondary battery.

### DETAILED DESCRIPTION

One or more embodiments of the present technology are described below in further detail including with reference to the drawings.

A description is given first of a secondary battery according to an embodiment of the present technology.

The secondary battery to be described here is a secondary battery that obtains a battery capacity using insertion and extraction of an electrode reactant, and includes a positive electrode, a negative electrode, and an electrolytic solution which is a liquid electrolyte.

Although not particularly limited in kind, the electrode reactant is specifically a light metal such as an alkali metal or an alkaline earth metal. Specific examples of the alkali metal include lithium, sodium, and potassium. Specific examples of the alkaline earth metal include beryllium, magnesium, and calcium.

Examples are given below of a case where the electrode reactant is lithium. A secondary battery that obtains a battery capacity using insertion and extraction of lithium is what is called a lithium-ion secondary battery. In the lithium-ion secondary battery, lithium is inserted and extracted in an ionic state.

Here, a charge capacity of the negative electrode is greater than a discharge capacity of the positive electrode. In other words, an electrochemical capacity per unit area of the negative electrode is set greater than an electrochemical capacity per unit area of the positive electrode. This is to prevent precipitation of the electrode reactant on a surface of the negative electrode during charging.

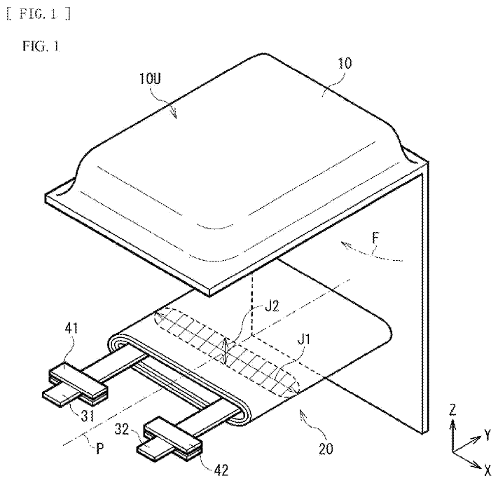

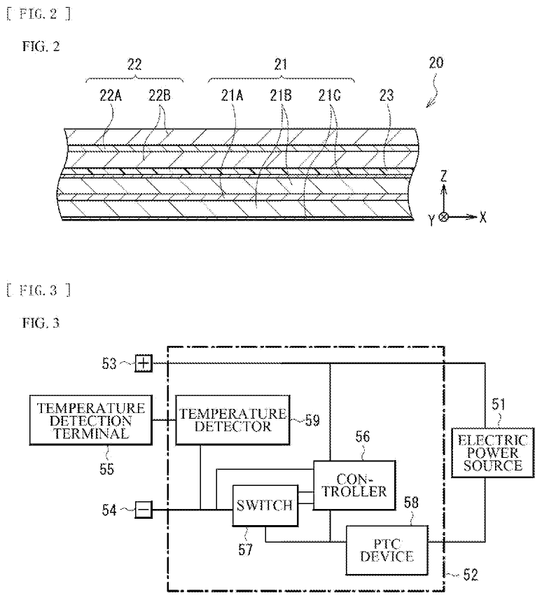

FIG. 1 illustrates a perspective configuration of the secondary battery. FIG. 2 illustrates a sectional configuration of a battery device 20 illustrated in FIG. 1.

Note that FIG. 1 illustrates a state in which an outer package film 10 and the battery device 20 are separated away from each other, and a section of the battery device 20 along an XZ plane is indicated by a dashed line. FIG. 2 illustrates only a portion of the battery device 20 in an enlarged manner.

As illustrated in FIGS. 1 and 2, the secondary battery includes the outer package film 10, the battery device 20, a positive electrode lead 31, a negative electrode lead 32, and sealing films 41 and 42. The secondary battery described here is a secondary battery of a laminated-film type in which the outer package film 10 having flexibility or softness is used.

As illustrated in FIG. 1, the outer package film 10 is a flexible outer package member that contains the battery device 20. The battery device 20 is sealed in a state of being contained inside the outer package film 10. That is, the outer package film 10 has a pouch-shaped structure, and contains a positive electrode 21, a negative electrode 22, and an electrolytic solution that are to be described later.

Here, the outer package film 10 is a single film-shaped member and is folded toward a direction F. The outer package film 10 has a depression part 10U to place the battery device 20 therein. The depression part 10U is what is called a deep drawn part.

Specifically, the outer package film 10 is a laminated film including three layers, which are a fusion-bonding layer, a metal layer, and a surface protective layer stacked in this order from an inner side. In a state in which the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers. In a case where the outer package film 10 is a laminated film including two or more layers, a material included in each of the layers may be selected as desired.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry, for example, of outside air into the outer package film 10. Specifically, the sealing film 41 includes a polymer compound such as a polyolefin that has adherence to the positive electrode lead 31. Specific examples of the polyolefin include polypropylene.

A configuration of the sealing film 42 is similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

As illustrated in FIGS. 1 and 2, the battery device 20 is an electric power generating device including the positive electrode 21, the negative electrode 22, a separator 23, and the electrolytic solution (not illustrated). The battery device 20 is contained inside the outer package film 10.

Here, the battery device 20 is what is called a wound electrode body. That is, in the battery device 20, the positive electrode 21 and the negative electrode 22 are stacked on each other with the separator 23 interposed therebetween, and the positive electrode 21, the negative electrode 22, and the separator 23 are wound about a virtual axis extending in a Y-axis direction, that is, a winding axis P. Thus, the positive electrode 21 and the negative electrode 22 are opposed to each other with the separator 23 interposed therebetween, and are wound.

A three-dimensional shape of the battery device 20 is not particularly limited. Here, the battery device 20 has an elongated three-dimensional shape. Accordingly, a section of the battery device 20 intersecting the winding axis P, that is, a section of the battery device 20 along the XZ plane, has an elongated shape defined by a major axis J1 and a minor axis J2. The major axis J1 is a virtual axis that extends in an X-axis direction and has a length larger than a length of the minor axis J2. The minor axis J2 is a virtual axis that extends in a Z-axis direction intersecting the X-axis direction and has the length smaller than the length of the major axis J1. Here, the battery device 20 has an elongated cylindrical three-dimensional shape. Thus, the section of the battery device 20 has an elongated, substantially elliptical shape.

The positive electrode 21 includes, as illustrated in FIG. 2, a positive electrode current collector 21A, a positive electrode active material layer 21B, and a film 21C.

The positive electrode current collector 21A has two opposed surfaces on which the respective positive electrode active material layers 21B are to be provided, and supports the positive electrode active material layers 21B. The positive electrode current collector 21A includes an electrically conductive material such as a metal material. Specific examples of the metal material include aluminum.

The positive electrode active material layer 21B includes one or more of positive electrode active materials into which lithium is insertable and from which lithium is extractable. Note that the positive electrode active material layer 21B may further include one or more of other materials including, without limitation, a positive electrode binder and a positive electrode conductor.

Here, the positive electrode active material layer 21B is provided on each of the two opposed surfaces of the positive electrode current collector 21A. Note that the positive electrode active material layer 21B may be provided only on one of the two opposed surfaces of the positive electrode current collector 21A. A method of forming the positive electrode active material layer 21B is not particularly limited, and specifically includes one or more of methods including, without limitation, a coating method.

The positive electrode active material is not particularly limited in kind. Specifically, the positive electrode active material includes a lithium-containing compound. The lithium-containing compound is a compound including lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table of elements. The lithium-containing compound is not particularly limited in kind, and specifically includes, for example, an oxide, a phosphoric acid compound, a silicic acid compound, and a boric acid compound.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

In particular, the positive electrode active material preferably includes one or more of lithium-cobalt composite oxides represented by Formula (1). A reason for this is that the film 21C is formed more easily on a surface of the positive electrode active material layer 21B, and the later-described physical property condition regarding a physical property of the film 21C is satisfied more easily.

LiₓCo_{y}M_{1-y}O₂ (1)
where:
M is at least one of Ni, Mn, Mg, Al, B, Ti, V, Cr, Fe, Cu, Zn, Mo, Sn, Ca, Sr, or W;
and
x and y satisfy 0.8≤x≤1.2 and 0.5≤y≤1.

The lithium-cobalt composite oxide is an oxide including lithium and cobalt as constituent elements. A composition of lithium differs in accordance with a charge and discharge state. A value of x in Formula (1) is a value in a fully discharged state.

As is apparent from a possible value range (0.5≤y≤1) of y in Formula (1), the lithium-cobalt composite oxide may, but does not necessarily have to, include an additional element (M) as a constituent element. The additional element (M) is not particularly limited in kind as long as the additional element (M) is one or more of nickel, etc. as described above.

The lithium-cobalt composite oxide that does not include the additional element (M) as a constituent element is LiCoO₂. Specific examples of the lithium-cobalt composite oxide that includes the additional element (M) as a constituent element include LiCoO_{0.99}Al_{0.01}O₂ and LiCo_{0.98}Al_{0.01}Mg_{0.01}O₂.

The positive electrode binder includes one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The positive electrode conductor includes one or more of electrically conductive materials including, without limitation, a carbon material. Specific examples of the carbon material include graphite, carbon black, acetylene black, and Ketjen black. The electrically conductive material may be a metal material or a polymer compound, for example.

The film 21C covers the surface of the positive electrode active material layer 21B. In this case, the film 21C may cover the entire surface of the positive electrode active material layer 21B, or may cover only a portion of the surface of the positive electrode active material layer 21B. In the latter case, multiple films 21C may cover the surface of the positive electrode active material layer 21B at respective locations separate from each other. FIG. 2 illustrates a case where the film 21C covers the entire surface of the positive electrode active material layer 21B.

Here, as will be described later, the film 21C is formed on the surface of each of the positive electrode active material layers 21B through a stabilization process (a first charge process and a storage process after the charge process) on the secondary battery after being assembled in a process of manufacturing the secondary battery, and includes cobalt, carbon, nitrogen, boron, and oxygen as constituent elements.

In this case, the positive electrode active material layer 21B preferably includes the lithium-cobalt composite oxide as described above, and the electrolytic solution preferably includes a dinitrile compound and a boron- and fluorine-containing lithium salt as will be described later.

In the above-described stabilization process of the secondary battery, a portion of the positive electrode active material (lithium-cobalt composite oxide) included in the positive electrode active material layer 21B undergoes decomposition and reaction, and a portion of each of the dinitrile compound and the boron- and fluorine-containing lithium salt included in the electrolytic solution undergoes decomposition and reaction. This makes it easier for the film 21C to include a cobalt compound (Co(CN)₂) and a boron compound (BOₓ) derived from the lithium-cobalt composite oxide, the dinitrile compound, and the boron- and fluorine-containing lithium salt. It is thus easier for the film 21C to include cobalt, carbon, nitrogen, boron, and oxygen as constituent elements as described above.

Because the lithium-cobalt composite oxide includes cobalt and oxygen as constituent elements, the lithium-cobalt composite oxide is a source of cobalt and oxygen. Because the dinitrile compound includes carbon and nitrogen as constituent elements, the dinitrile compound is a source of carbon and nitrogen. Because the boron- and fluorine-containing lithium salt includes boron as a constituent element, the boron- and fluorine-containing lithium salt is a source of boron. Details of the dinitrile compound and details of the boron- and fluorine-containing lithium salt will be described later.

In the secondary battery, a predetermined physical property condition is satisfied regarding the physical property of the film 21C, in order to improve each of a battery capacity characteristic, a swelling characteristic, and an electric resistance characteristic. Details of the physical property condition of the film 21C will be described later.

The negative electrode 22 includes, as illustrated in FIG. 2, a negative electrode current collector 22A and a negative electrode active material layer 22B.

The negative electrode current collector 22A has two opposed surfaces on which the respective negative electrode active material layers 22B are to be provided, and supports the negative electrode active material layers 22B. The negative electrode current collector 22A includes an electrically conductive material such as a metal material. Specific examples of the metal material include copper.

The negative electrode active material layer 22B includes one or more of negative electrode active materials into which lithium is insertable and from which lithium is extractable. Note that the negative electrode active material layer 22B may further include one or more of other materials including, without limitation, a negative electrode binder and a negative electrode conductor.

Here, the negative electrode active material layer 22B is provided on each of the two opposed surfaces of the negative electrode current collector 22A. Note that the negative electrode active material layer 22B may be provided only on one of the two opposed surfaces of the negative electrode current collector 22A. A method of forming the negative electrode active material layer 22B is not particularly limited, and specifically includes one or more of methods including, without limitation, a coating method, a vapor-phase method, a liquid-phase method, a thermal spraying method, and a firing (sintering) method.

The negative electrode active material is not particularly limited in kind, and specifically includes a carbon material, a metal-based material, or both. A reason for this is that a high energy density is obtainable.

Specific examples of the carbon material include graphitizable carbon, non-graphitizable carbon, and graphite (natural graphite and artificial graphite).

The metal-based material is a material that includes, as one or more constituent elements, one or more elements among metal elements and metalloid elements that are each able to form an alloy with lithium. More specifically, the metal-based material is a material that includes, as one or more constituent elements, one or more of, for example, silicon and tin. The metal-based material may be a simple substance, an alloy, a compound, a mixture of two or more thereof, or a material including two or more phases thereof. Specific examples of the metal-based material include TiSi₂ and SiOₓ (0≤x≤2 or 0.2≤x≤1.4).

Details of the negative electrode binder are similar to those of the positive electrode binder. Details of the negative electrode conductor are similar to those of the positive electrode conductor.

The separator 23 is an insulating porous film interposed between the positive electrode 21 and the negative electrode 22 as illustrated in FIG. 2, and allows lithium ions to pass therethrough while preventing contact (a short circuit) between the positive electrode 21 and the negative electrode 22. The separator 23 includes a polymer compound such as polyethylene.

The positive electrode 21, the negative electrode 22, and the separator 23 are each impregnated with the electrolytic solution. The electrolytic solution includes a solvent and an electrolyte salt.

The solvent includes one or more of non-aqueous solvents (organic solvents), and the electrolytic solution including the non-aqueous solvent(s) is what is called a non-aqueous electrolytic solution.

The non-aqueous solvent includes, for example, an ester or an ether, more specifically, a carbonic-acid-ester-based compound, a carboxylic-acid-ester-based compound, or a lactone-based compound, for example.

The carbonic-acid-ester-based compound is a cyclic carbonic acid ester or a chain carbonic acid ester, for example. Specific examples of the cyclic carbonic acid ester include ethylene carbonate and propylene carbonate, and specific examples of the chain carbonic acid ester include dimethyl carbonate, diethyl carbonate, and methyl ethyl carbonate. The carboxylic-acid-ester-based compound is a chain carboxylic acid ester, for example. Specific examples of the chain carboxylic acid ester include ethyl acetate, propyl acetate, ethyl propionate, propyl propionate, and ethyl trimethylacetate. The lactone-based compound is a lactone, for example. Specific examples of the lactone include y-butyrolactone and γ-valerolactone. Note that the ether may be the lactone-based compound described above, 1,2-dimethoxyethane, tetrahydrofuran, 1,3-dioxolane, or 1,4-dioxane, for example.

Further, the non-aqueous solvent may include one or more of materials including, without limitation, an unsaturated cyclic carbonic acid ester, a halogenated carbonic acid ester, a sulfonic acid ester, a phosphoric acid ester, an acid anhydride, a nitrile compound, and an isocyanate compound. A reason for this is that chemical stability of the electrolytic solution improves. Note that the dinitrile compound, which will be described later, is excluded from the nitrile compound described here.

Specific examples of the unsaturated cyclic carbonic acid ester include vinylene carbonate, vinylethylene carbonate, and methylene ethylene carbonate. The halogenated carbonic acid ester is a halogenated cyclic carbonic acid ester or a halogenated chain carbonic acid ester, for example. Specific examples of the halogenated cyclic carbonic acid ester include monofluoroethylene carbonate and difluoroethylene carbonate. Specific examples of the halogenated chain carbonic acid ester include fluoromethyl methyl carbonate, bis(fluoromethyl) carbonate, and difluoromethyl methyl carbonate. Specific examples of the sulfonic acid ester include propane sultone and propene sultone. Specific examples of the phosphoric acid ester include trimethyl phosphate and triethyl phosphate.

The acid anhydride is a cyclic dicarboxylic acid anhydride, a cyclic disulfonic acid anhydride, or a cyclic carboxylic acid sulfonic acid anhydride, for example. Specific examples of the cyclic dicarboxylic acid anhydride include succinic anhydride, glutaric anhydride, and maleic anhydride. Specific examples of the cyclic disulfonic acid anhydride include ethanedisulfonic acid anhydride and propanedisulfonic acid anhydride. Specific examples of the cyclic carboxylic acid sulfonic acid anhydride include sulfobenzoic acid anhydride, sulfopropionic acid anhydride, and sulfobutyric acid anhydride.

The nitrile compound includes a mononitrile compound and a trinitrile compound, for example. Specific examples of the mononitrile compound include acetonitrile. Specific examples of the trinitrile compound include 1,2,3-propanetricarbonitrile, 1,3,5-pentanetricarbonitrile, 1,3,4-hexanetricarbonitrile, 1,3,6-hexanetricarbonitrile, 1,3,5-cyclohexanetricarbonitrile, and 1,3,5-benzenetricarbonitrile. Specific examples of the isocyanate compound include hexamethylene diisocyanate.

The electrolyte salt includes one or more of light metal salts including, without limitation, a lithium salt. Specific examples of the lithium salt include lithium hexafluorophosphate (LiPF₆), lithium trifluoromethanesulfonate (LiCF₃SO₃), lithium bi s(fluorosulfonyl)imide (LiN(FSO₂)₂), lithium bis(trifluoromethanesulfonyl)imide (LiN(CF₃SO₂)₂), lithium bis(pentafluoroethanesulfonyl)imide (LiN(C₂F₅SO₂)₂), lithium tris(trifluoromethanesulfonyl)methide (LiC(CF₃SO₂)₃), lithium bis(oxalato)borate (LiB(C₂O₄)₂), lithium monofluorophosphate (Li₂PFO₃), and lithium difluorophosphate (LiPF₂O₂).

A content of the electrolyte salt is not particularly limited, and is specifically within a range from 0.3 mol/kg to 3.0 mol/kg both inclusive with respect to the solvent. A reason for this is that high ion conductivity is obtainable.

Note that, as described above, the electrolytic solution may include the dinitrile compound and the boron- and fluorine-containing lithium salt. A reason for this is that the film 21C is formed more easily on the surface of the positive electrode active material layer 21B, and the later-described physical property condition regarding the physical property of the film 21C is satisfied more easily. Only one dinitrile compound may be used, or two or more dinitrile compounds may be used. Similarly, only one boron- and fluorine-containing lithium salt may be used, or two or more boron- and fluorine-containing lithium salts may be used.

A reason why the electrolytic solution includes the dinitrile compound and the boron- and fluorine-containing lithium salt together is that the film 21C is more easily formed on the surface of the positive electrode active material layer 21B owing to the decomposition and the reaction of each of the dinitrile compound and the boron- and fluorine-containing lithium salt upon the stabilization process of the secondary battery. In this case, even if a portion of the film 21C is decomposed upon charging and discharging, the film 21C is more easily additionally formed owing to the decomposition and the reaction of each of the dinitrile compound and the boron- and fluorine-containing lithium salt at a subsequent cycle of charging and discharging.

The dinitrile compound is an aliphatic hydrocarbon compound having two nitrile groups (—CN). Each of the nitrile groups is not particularly limited in boding position and may thus be bonded to a carbon atom located at a terminal of a carbon chain, or may thus be bonded to a carbon atom located at some point in the middle of the carbon chain.

Specifically, the dinitrile compound includes one or more of compounds represented by Formula (2). In the dinitrile compound represented by Formula (2), the nitrile groups are bonded to two respective carbon atoms located at both terminals of the carbon chain.

NC—R—CN (2)

where R is an alkylene group.

The alkylene group may have: a straight-chain structure; or a branched structure having one or more side chains. Carbon number of the alkylene group is not particularly limited, but is preferably within a range from 2 to 10 both inclusive. A reason for this is that the film 21C is more easily formed on the surface of the positive electrode active material layer 21B.

The specific examples of the dinitrile compound include succinonitrile (carbon number of alkylene group=2), glutaronitrile (carbon number of alkylene group=3), adiponitrile (carbon number of alkylene group=4), pimelonitrile (carbon number of alkylene group=5), suberonitrile (carbon number of alkylene group=6), azelanitrile (carbon number of alkylene group=7), sebaconitrile (carbon number of alkylene group=8), undecanedinitrile (carbon number of alkylene group=9), and dodecanedinitrile (carbon number of alkylene group=10).

In particular, the dinitrile compound preferably includes succinonitrile, adiponitrile, or both. A reason for this is that the film 21C is sufficiently more easily formed on the surface of the positive electrode active material layer 21B.

A content of the dinitrile compound in the electrolytic solution is not particularly limited, but is preferably within a range from 3 wt % to 10 wt % both inclusive. A reason for this is that the film 21C is sufficiently more easily formed on the surface of the positive electrode active material layer 21B.

The boron- and fluorine-containing lithium salt is a lithium salt that includes boron and fluorine as constituent elements and also functions as an electrolyte salt.

Specific examples of the boron- and fluorine-containing lithium salt include lithium tetrafluoroborate (LiBF₄) and lithium difluoro(oxalato)borate (LiBF₂(C₂O₄)). A reason for this is that the film 21C is more easily formed on the surface of the positive electrode active material layer 21B.

In particular, the boron- and fluorine-containing lithium salt is preferably lithium tetrafluoroborate. A reason for this is that the film 21C is sufficiently more easily formed on the surface of the positive electrode active material layer 21B.

A content of the boron- and fluorine-containing lithium salt in the electrolytic solution is not particularly limited, but is preferably within a range from 0.5 wt % to 1.3 wt % both inclusive. A reason for this is that the film 21C is sufficiently more easily formed on the surface of the positive electrode active material layer 21B.

As illustrated in FIGS. 1 and 2, the positive electrode lead 31 is a positive electrode wiring line coupled to the positive electrode current collector 21A of the positive electrode 21, and is led from an inside to an outside of the outer package film 10. The positive electrode lead 31 includes an electrically conductive material such as a metal material. Specific examples of the metal material include aluminum. The positive electrode lead 31 has a shape such as a thin plate shape or a meshed shape.

As illustrated in FIGS. 1 and 2, the negative electrode lead 32 is a negative electrode wiring line coupled to the negative electrode current collector 22A of the negative electrode 22, and is led from the inside to the outside of the outer package film 10. Here, the negative electrode lead 32 is led toward a direction similar to that in which the positive electrode lead 31 is led out. The negative electrode lead 32 includes an electrically conductive material such as a metal material. Specific examples of the metal material include copper. Details of a shape of the negative electrode lead 32 are similar to those of the shape of the positive electrode lead 31.

In the secondary battery, as described above, the predetermined physical property condition is satisfied regarding the physical property of the film 21C, in order to improve each of the battery capacity characteristic, the swelling characteristic, and the electric resistance characteristic.

Specifically, the film 21C includes cobalt, carbon, nitrogen, boron, and oxygen as constituent elements as described above. Thus, based on a negative ion analysis of the film 21C by time-of-flight secondary ion mass spectrometry (TOF-SIMS), a first peak derived from CoC₂N₂⁻ and a second peak derived from BOₓ⁻ are detectable. In this case, an intensity ratio R (=I2/I1) which is a ratio of an intensity I2 of the second peak to an intensity I1 of the first peak is within a range from 0.19 to 1.00 both inclusive. Note that a value of the intensity ratio R is rounded off to two decimal places.

A reason why the above-described physical property condition (the intensity ratio R within the range from 0.19 to 1.00 both inclusive) regarding the physical property of the film 21C is satisfied is that a film quality of the film 21C is made appropriate, which increases a density of the film 21C. Thus, the film 21C is favorably formed with small thickness but high durability on the surface of the positive electrode active material layer 21B. This suppresses a decomposition reaction of the electrolytic solution on a surface of the positive electrode 21, while suppressing an increase in electric resistance and securing smooth insertion and extraction performance of lithium in the positive electrode 21.

More specifically, when the positive electrode active material includes the lithium-cobalt composite oxide, and the electrolytic solution includes the dinitrile compound and the boron- and fluorine-containing lithium salt, the advantages described below are obtainable.

Because the dinitrile compound is firmly bonded to cobalt or a cobalt oxide in the lithium-cobalt composite oxide, the physical strength and the chemical strength of the film 21C are improved. Thus, the film 21C protects the surface of the positive electrode active material layer 21B that has reactivity. This sufficiently suppresses the decomposition reaction of the electrolytic solution on the surface of the positive electrode 21.

Further, even if lithium fluoride (LiF) having a high electric resistance is formed on the surface of the positive electrode 21 upon charging and discharging, the boron- and fluorine-containing lithium salt promotes a decomposition reaction of the lithium fluoride, which reduces deposition of the lithium fluoride on the surface of the positive electrode 21. This sufficiently suppresses an increase in the electric resistance of the positive electrode 21.

Note that, in a case of performing the negative ion analysis of the film 21C by TOF-SIMS, TOF-SIMS5, a TOF-SIMS spectrometer available from ION-TOF, for example, is usable. Analysis conditions are as follows. Primary ion species: Bi³⁺; primary ion acceleration voltage: 25 kV; peak width: 15.2 ns; primary ion current: less than or equal to 0.3 pA; and scan range: 200 μm×200 μm.

Further, in a case of preparing the film 21C for analysis, the secondary battery is disassembled in an atmosphere of an inert gas such as argon, to thereby collect the positive electrode 21 including the film 21C. Thereafter, the surface of the positive electrode 21 is washed using an organic solvent such as dimethyl carbonate. A time for washing is not particularly limited and is specifically approximately 30 seconds. In the case of performing the negative ion analysis, the positive electrode 21 is preferably put in a TOF-SIMS spectrometer in an environment that has been vacuum-processed overnight using an inert gas such as argon.

As will be described later, the intensity ratio R is adjustable to a desired value by changing the conditions in a case of performing the stabilization process on the secondary battery. In this case, because the intensities I1 and I2 are each varied in accordance with the conditions in the case of performing the stabilization process on the secondary battery, the intensity ratio R is also varied. Specifically, the conditions in the case of performing the stabilization process on the secondary battery include, for example, an upper limit voltage, an environmental temperature, and a storage period as will be described later.

Upon charging of the secondary battery, in the battery device 20, lithium is extracted from the positive electrode 21, and the extracted lithium is inserted into the negative electrode 22 via the electrolytic solution. Upon discharging of the secondary battery, in the battery device 20, lithium is extracted from the negative electrode 22, and the extracted lithium is inserted into the positive electrode 21 via the electrolytic solution. Upon charging and discharging, lithium is inserted and extracted in an ionic state.

The secondary battery is manufactured based on a procedure to be described below. In this case, the secondary battery is assembled using a positive electrode precursor, the negative electrode 22, and the electrolytic solution, following which the stabilization process is performed on the secondary battery.

In the following description, a method of manufacturing the secondary battery will be described in which the positive electrode active material layer 21B includes the lithium-cobalt composite oxide, and the electrolytic solution includes the dinitrile compound and the boron- and fluorine-containing lithium salt.

First, the positive electrode active material including the lithium-cobalt composite oxide, the positive electrode binder, and the positive electrode conductor are mixed with each other to thereby obtain a mixture (positive electrode mixture). The mixture is put into a solvent to thereby prepare a positive electrode mixture slurry in a paste form. The solvent may be an aqueous solvent, or may be an organic solvent. Thereafter, the positive electrode mixture slurry is applied on the two opposed surfaces of the positive electrode current collector 21A to thereby form the positive electrode active material layers 21B. Thereafter, the positive electrode active material layers 21B are compression-molded by means of a roll pressing machine, for example. In this case, the positive electrode active material layers 21B may be heated. The positive electrode active material layers 21B may be compression-molded multiple times. In this manner, the positive electrode active material layers 21B are formed on the respective two opposed surfaces of the positive electrode current collector 21A. Thus, the positive electrode precursor (not illustrated) is fabricated. The positive electrode precursor has a configuration similar to that of the positive electrode 21 except that the positive electrode precursor does not include the film 21C.

Lastly, as will be described later, the secondary battery is assembled using the positive electrode precursor, following which the stabilization process is performed on the secondary battery. This forms the film 21C on the surface of each of the positive electrode active material layers 21B. In this manner, the positive electrode active material layers 21B and the films 21C are formed on the respective two opposed surfaces of the positive electrode current collector 21A. Thus, the positive electrode 21 is fabricated.

First, the negative electrode active material, the negative electrode binder, and the negative electrode conductor are mixed with each other to thereby obtain a mixture (negative electrode mixture). The mixture is put into a solvent to thereby prepare a negative electrode mixture slurry in a paste form. Details of the solvent are as described above. Thereafter, the negative electrode mixture slurry is applied on the two opposed surfaces of the negative electrode current collector 22A to thereby form the negative electrode active material layers 22B. Lastly, the negative electrode active material layers 22B are compression-molded by means of a roll pressing machine, for example. Details of the compression molding are as described above. In this manner, the negative electrode active material layers 22B are formed on the respective two opposed surfaces of the negative electrode current collector 22A. Thus, the negative electrode 22 is fabricated.

The electrolyte salt is put into the solvent, following which the dinitrile compound and the boron- and fluorine-containing lithium salt are added to the solvent. The electrolyte salt, the dinitrile compound, and the boron- and fluorine-containing lithium salt are thereby each dispersed or dissolved in the solvent. As a result, the electrolytic solution is prepared.

First, the positive electrode lead 31 is coupled to the positive electrode current collector 21A of the positive electrode precursor by a method such as a welding method, and the negative electrode lead 32 is coupled to the negative electrode current collector 22A of the negative electrode 22 by a method such as a welding method.

Thereafter, the positive electrode precursor and the negative electrode 22 are stacked on each other with the separator 23 interposed therebetween, following which the stack of the positive electrode precursor, the negative electrode 22, and the separator 23 is wound to thereby fabricate a wound body (not illustrated). The wound body has a configuration similar to that of the battery device 20 except that the wound body includes the positive electrode precursor instead of the positive electrode 21, and that the positive electrode precursor, the negative electrode 22, and the separator 23 are each not impregnated with the electrolytic solution. Thereafter, the wound body is pressed by means of, for example, a pressing machine to thereby shape the wound body into an elongated shape.

Thereafter, the wound body is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the outer package film 10 (the fusion-bonding layer) opposed to each other are fusion-bonded to each other by a method such as a thermal-fusion-bonding method to thereby allow the wound body to be contained inside the outer package film 10 having a pouch shape.

Lastly, the electrolytic solution is injected into the outer package film 10 having the pouch shape, following which outer edge parts of the remaining one side of the outer package film 10 (the fusion-bonding layer) are fusion-bonded to each other by a method such as a thermal-fusion-bonding method. In this case, the sealing film 41 is interposed between the outer package film 10 and the positive electrode lead 31, and the sealing film 42 is interposed between the outer package film 10 and the negative electrode lead 32. In this manner, the wound body is impregnated with the electrolytic solution, and the wound body is sealed inside the outer package film 10 having the pouch shape. As a result, the secondary battery is assembled.

The assembled secondary battery is charged, following which the charged secondary battery is stored. As a result, each of the dinitrile compound and the boron- and fluorine-containing lithium salt included in the electrolytic solution decomposes and reacts, and the film 21C is thus formed on the surface of each of the positive electrode active material layers 21B. In this manner, the positive electrode active material layers 21B and the films 21C are formed on the respective two opposed surfaces of the positive electrode current collector 21A. Thus, the positive electrode 21 is fabricated.

As a result, the battery device 20 is fabricated, and the state of the battery device 20 is electrochemically stabilized. The secondary battery is thus completed.

During the stabilization process of the secondary battery, a target voltage (upper limit voltage (V)) at the time of charging is made sufficiently high, a temperature of an environment (environmental temperature (° C.)) at which the charged secondary battery is stored is made sufficiently high, and a period during which the charged secondary battery is stored (storage period (hours)) is made sufficiently long, in order to favorably form the film 21C with small thickness but high durability.

Specifically, the upper limit voltage is higher than or equal to 4.35 V, and more specifically, within a range from 4.35 V to 4.45 V both inclusive. The environmental temperature is higher than or equal to 45° C., and more specifically, within a range from 45° C. to 60° C. both inclusive. The storage period is longer than or equal to 10 hours, and more specifically, within a range from 10 hours to 48 hours both inclusive.

Note that the storage period may be set as desired in relation to the environmental temperature, and the environmental temperature may be set as desired in relation to the storage period. Specifically, when the storage period is relatively short, the environmental temperature is preferably relatively high within the range described above, and when the storage period is relatively long, the environmental temperature may be relatively low within the range described above. Further, when the environmental temperature is relatively low, the storage period is preferably relatively long within the range described above, and when the environmental temperature is high, the storage period may be relatively short within the range described above.

As described above, the intensity ratio R is controllable based on the conditions (the upper limit voltage, the environmental temperature, and the storage period) in the case of performing the stabilization process on the secondary battery.

After the stabilization process on the secondary battery is completed, that is, after the film 21C is formed on the surface of each of the positive electrode active material layers 21B, each of the dinitrile compound and the boron- and fluorine-containing lithium salt used to form the film 21C may, but does not necessarily have to, remain in the electrolytic solution.

According to the secondary battery, the positive electrode 21 includes the positive electrode active material layer 21B and the film 21C, and the film 21C includes cobalt, carbon, nitrogen, boron, and oxygen as constituent elements. The intensity ratio R defined by a result of the negative ion analysis of the film 21C by TOF-SIMS is within the range from 0.19 to 1.00 both inclusive.

In this case, the intensity ratio R is made appropriate, that is, a balance between an abundance of a component derived from CoC₂N₂⁻ and an abundance of a component derived from BOₓ⁻ is made appropriate in the film 21C. The film 21C is thus favorably formed with small thickness but high durability on the surface of the positive electrode active material layer 21B as described above. This suppresses the decomposition reaction of the electrolytic solution on the surface of the positive electrode 21, while suppressing an increase in electric resistance and securing smooth insertion and extraction performance of lithium in the positive electrode 21.

More specifically, if the intensity ratio R is less than 0.19, the intensity ratio R is too small, which secures the smooth insertion and extraction performance of lithium and suppresses the decomposition reaction of the electrolytic solution, but increases the electric resistance of the positive electrode 21. However, if the intensity ratio R is greater than or equal to 0.19, the electric resistance of the positive electrode 21 is decreased while the smooth insertion and extraction performance of lithium is secured, and the decomposition reaction of the electrolytic solution is suppressed.

If the intensity ratio R is greater than 1.00, the intensity ratio R is too large, which decreases the electric resistance of the positive electrode 21, but inhibits the smooth insertion and extraction performance of lithium and causes a significant decomposition reaction of the electrolytic solution. However, if the intensity ratio R is less than or equal to 1.00, the smooth insertion and extraction performance of lithium is secured, and the decomposition reaction of the electrolytic solution is suppressed while the electric resistance of the positive electrode 21 is decreased.

As a result, lithium is smoothly inserted and extracted and the electric resistance of the positive electrode 21 decreases, while swelling of the secondary battery due to the decomposition reaction of the electrolytic solution (gas generation) is suppressed. In this case, particularly, because the film quality of the film 21C is sufficiently improved, even if the secondary battery is used and stored in a high-temperature environment, or more specifically, in a high-temperature environment of higher than or equal to 60° C., the swelling is effectively suppressed, and the electric resistance is effectively decreased. It is thus possible to achieve a superior battery capacity characteristic, a superior swelling characteristic, and a superior electric resistance characteristic.

In particular, the electrolytic solution may include the dinitrile compound and the boron- and fluorine-containing lithium salt. This makes it easier for the film 21C to be formed on the surface of the positive electrode active material layer 21B and for the above-described physical property condition (the intensity ratio R within the range from 0.19 to 1.00 both inclusive) regarding the physical property of the film 21C to be satisfied. Accordingly, it is possible to achieve higher effects. In this case, the electrolytic solution may include the dinitrile compound and the boron- and fluorine-containing lithium salt even after the stabilization process of the secondary battery (i.e., after the formation of the film 21C). This makes it easier for the film 21C to be additionally formed upon charging and discharging. Accordingly, it is possible to achieve further higher effects.

Further, the dinitrile compound may include succinonitrile, adiponitrile, or both, and the boron- and fluorine-containing lithium salt may include lithium tetrafluoroborate. This makes it sufficiently easier for the film 21C to be formed on the surface of the positive electrode active material layer 21B. Accordingly, it is possible to achieve higher effects. In this case, the content of the dinitrile compound in the electrolytic solution may be within the range from 3 wt % to 10 wt % both inclusive, and the content of the boron- and fluorine-containing lithium salt in the electrolytic solution may be within the range from 0.5 wt % to 1.3 wt % both inclusive. This makes it easier for the film 21C to be formed on the surface of the positive electrode active material layer 21B. Accordingly, it is possible to achieve further higher effects.

Further, the positive electrode active material layer 21B may include the lithium-cobalt composite oxide. This makes it easier for the film 21C to be formed on the surface of the positive electrode active material layer 21B and for the above-described physical property condition (the intensity ratio R within the range from 0.19 to 1.00 both inclusive) regarding the physical property of the film 21C to be satisfied. Accordingly, it is possible to achieve higher effects.

Further, the secondary battery may include the outer package film 10 having flexibility. Using the outer package film 10 having flexibility also effectively suppresses the swelling of the secondary battery. Accordingly, it is possible to achieve higher effects.

Further, the secondary battery may include a lithium-ion secondary battery. This makes it possible to obtain a sufficient battery capacity stably through the use of insertion and extraction of lithium. Accordingly, it is possible to achieve higher effects.

The configuration of the secondary battery is appropriately modifiable as described below according to an embodiment. Note that any two or more of the following series of modifications may be combined with each other.

The separator 23 which is a porous film is used. However, although not specifically illustrated here, a separator of a stacked type including a polymer compound layer may be used instead of the separator 23 which is the porous film.

Specifically, the separator of the stacked type includes a porous film having two opposed surfaces, and the polymer compound layer provided on one of or each of the two opposed surfaces of the porous film. A reason for this is that adherence of the separator to each of the positive electrode 21 and the negative electrode 22 improves to suppress misalignment of the battery device 20, that is, irregular winding of each of the positive electrode 21, the negative electrode 22, and the separator. This suppresses the swelling of the secondary battery even if the decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include one or more kinds of insulating particles. A reason for this is that the insulating particles dissipate heat upon heat generation by the secondary battery, thus improving safety or heat resistance of the secondary battery. Examples of the insulating particles include inorganic particles and resin particles. Examples of the inorganic particles include particles of one or more of inorganic materials including, without limitation, aluminum oxide, aluminum nitride, boehmite, silicon oxide, titanium oxide, magnesium oxide, and zirconium oxide. The resin particles include one or more of resin materials including, without limitation, an acrylic resin and a styrene resin.

In a case of fabricating the separator of the stacked type, a precursor solution including, without limitation, the polymer compound and an organic solvent is prepared, following which the precursor solution is applied on one of or each of the two opposed surfaces of the porous film. In this case, insulating particles may be included in the precursor solution.

In the case where the separator of the stacked type is used also, lithium ions are movable between the positive electrode 21 and the negative electrode 22, and similar effects are therefore obtainable. In this case, particularly, the misalignment of the battery device 20 is suppressed, and accordingly, the swelling of the secondary battery is further suppressed as described above. Accordingly, it is possible to achieve higher effects.

The electrolytic solution which is a liquid electrolyte is used. However, although not specifically illustrated here, an electrolyte layer which is a gel electrolyte may be used instead of the electrolytic solution.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound. A reason for this is that leakage of the electrolytic solution is suppressed. The configuration of the electrolytic solution is as described above. The polymer compound includes, for example, polyvinylidene difluoride. In a case of forming the electrolyte layer, a precursor solution including, for example, the electrolytic solution, the polymer compound, and an organic solvent is prepared, following which the precursor solution is applied on one side or both sides of the positive electrode 21 and on one side or both sides of the negative electrode 22.

In a case where the electrolyte layer is used also, lithium ions are movable between the positive electrode 21 and the negative electrode 22 via the electrolyte layer, and similar effects are therefore obtainable. In this case, particularly, the leakage of the electrolytic solution is suppressed as described above. Accordingly, it is possible to achieve higher effects.

Next, a description is given of applications (application examples) of the above-described secondary battery according to an embodiment.

The applications of the secondary battery are not particularly limited. The secondary battery used as a power source serves as a main power source or an auxiliary power source of, for example, electronic equipment and an electric vehicle. The main power source is preferentially used regardless of the presence of any other power source. The auxiliary power source is used in place of the main power source, or is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems or industrial battery systems for accumulation of electric power for a situation such as emergency. The above-described applications may each use one secondary battery, or may each use multiple secondary batteries.

The battery packs may each include a single battery, or may each include an assembled battery. The electric vehicle is a vehicle that operates (travels) using the secondary battery as a driving power source, and may be a hybrid automobile that is additionally provided with a driving source other than the secondary battery. In an electric power storage system for home use, electric power accumulated in the secondary battery which is an electric power storage source may be utilized for using, for example, home appliances.

Here, one of application examples of the secondary battery will now be described in detail. The configuration of the application example described below is merely an example, and is appropriately modifiable.

FIG. 3 illustrates a block configuration of a battery pack. The battery pack described here is a battery pack (what is called a soft pack) including one secondary battery, and is to be mounted on, for example, electronic equipment typified by a smartphone.

As illustrated in FIG. 3, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a thermosensitive resistive device (a PTC device) 58, and a temperature detector 59. However, the PTC device 58 may be omitted.

The controller 56 includes, for example, a central processing unit (CPU) and a memory, and controls an overall operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage and the overdischarge detection voltage are not particularly limited. For example, the overcharge detection voltage is 4.2 V±0.05 V, and the overdischarge detection voltage is 2.4 V±0.1 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). The charging and discharging currents are detected based on an ON-resistance of the switch 57.

The temperature detector 59 includes a temperature detection device such as a thermistor. The temperature detector 59 measures a temperature of the electric power source 51 using the temperature detection terminal 55, and outputs a result of the temperature measurement to the controller 56. The result of the temperature measurement to be obtained by the temperature detector 59 is used, for example, in a case where the controller 56 performs charge and discharge control upon abnormal heat generation or in a case where the controller 56 performs a correction process upon calculating a remaining capacity.

### EXAMPLES

A description is given of Examples of the present technology below according to an embodiment.

### Examples 1 to 19 and Comparative Examples 1 to 18

Secondary batteries were manufactured, following which the secondary batteries were each evaluated for a battery characteristic.

### [Manufacturing of Secondary Battery]

The secondary batteries (lithium-ion secondary batteries of the laminated-film type) illustrated in FIGS. 1 and 2 were manufactured in accordance with the following procedure.

### (Fabrication of Positive Electrode)

First, 97.3 parts by mass of the positive electrode active material (lithium cobalt oxide (LiCoO₂) that was a lithium-cobalt composite oxide), 1.5 parts by mass of the positive electrode binder (polyvinylidene difluoride), and 1.2 parts by mass of the positive electrode conductor (graphite) were mixed with each other to thereby obtain a positive electrode mixture.

Thereafter, the positive electrode mixture was put into a solvent (N-methyl-2-pyrrolidone that was an organic solvent), following which the organic solvent was stirred to thereby prepare a positive electrode mixture slurry in a paste form. Thereafter, the positive electrode mixture slurry was applied on the two opposed surfaces of the positive electrode current collector 21A (a band-shaped aluminum foil having a thickness of 15 μm) by means of a coating apparatus, following which the applied positive electrode mixture slurry was dried to thereby form the positive electrode active material layers 21B. Thereafter, the positive electrode active material layers 21B were compression-molded by means of a roll pressing machine to thereby fabricate a positive electrode precursor.

Lastly, as will be described later, the secondary battery was assembled using the positive electrode precursor, following which the stabilization process was performed on the secondary battery to thereby form the film 21C. In this manner, the positive electrode 21 was fabricated.

### (Fabrication of Negative Electrode)

First, 94.5 parts by mass of the negative electrode active material (graphite), 3.3 parts by mass of the negative electrode binder (polyvinylidene difluoride), and 2.2 parts by mass of the negative electrode conductor (carbon black) were mixed with each other to thereby obtain a negative electrode mixture. Thereafter, the negative electrode mixture was put into a solvent (N-methyl-2-pyrrolidone that was an organic solvent), following which the organic solvent was stirred to thereby prepare a negative electrode mixture slurry in a paste form. Lastly, the negative electrode mixture slurry was applied on the two opposed surfaces of the negative electrode current collector 22A (a band-shaped copper foil having a thickness of 15 μm) by means of a coating apparatus, following which the applied negative electrode mixture slurry was dried to thereby form the negative electrode active material layers 22B. In this manner, the negative electrode 22 was fabricated.

### (Preparation of Electrolytic Solution)

The electrolyte salt (lithium hexafluorophosphate (LiPF₆)) was put into the solvent, following which the solvent was stirred. Used as the solvent were the cyclic carbonic acid ester (ethylene carbonate and propylene carbonate) and the chain carboxylic acid ester (propyl propionate and ethyl propionate). In this case, a mixture ratio (weight ratio) of the solvent between ethylene carbonate, propylene carbonate, propyl propionate, and ethyl propionate was set to 20:20:25:35, and a content of the electrolyte salt was set to 1.2 mol/kg with respect to the solvent.

Thereafter, the unsaturated cyclic carbonic acid ester (vinylene carbonate) and the halogenated carbonic acid ester (monofluoroethylene carbonate) were added to the solvent, following which the solvent was stirred.

Lastly, the dinitrile compound and the boron- and fluorine-containing lithium salt were added to the solvent, following which the solvent was stirred. The kind of the dinitrile compound and the kind of the boron- and fluorine-containing lithium salt were as listed in Tables 1 to 3. Here, succinonitrile (SN) and adiponitrile (AN) were used as the dinitrile compound, and lithium tetrafluoroborate (LiBF₄) was used as the boron- and fluorine-containing lithium salt. In this manner, the electrolytic solution was prepared.

Note that, for comparison, the electrolytic solution was prepared by a similar procedure except that only the dinitrile compound was used without using the boron- and fluorine-containing lithium salt. The kind of the dinitrile compound was as listed in Table 4. Here, suberonitrile (SUN) was additionally used as the dinitrile compound.

### (Assembly of Secondary Battery)

First, the positive electrode lead 31 (an aluminum foil) was welded to the positive electrode current collector 21A of the positive electrode precursor, and the negative electrode lead 32 (a copper foil) was welded to the negative electrode current collector 22A of the negative electrode 22.

Thereafter, the positive electrode precursor and the negative electrode 22 were stacked on each other with the separator 23 (a fine-porous polyethylene film having a thickness of 25 μm) interposed therebetween, following which the stack of the positive electrode precursor, the negative electrode 22, and the separator 23 was wound to thereby fabricate the wound body. Thereafter, the wound body was pressed by means of a pressing machine and was thereby shaped into an elongated shape.

Thereafter, the outer package film 10 (the fusion-bonding layer/the metal layer/the surface protective layer) was folded in such a manner as to sandwich the wound body contained inside the depression part 10U, following which the outer edge parts of two sides of the outer package film 10 (the fusion-bonding layer) were thermal-fusion-bonded to each other to thereby allow the wound body to be contained inside the outer package film 10 having the pouch shape. As the outer package film 10, an aluminum laminated film was used in which the fusion-bonding layer (a polypropylene film having a thickness of 30 μm), the metal layer (an aluminum foil having a thickness of 40 μm), and the surface protective layer (a nylon film having a thickness of 25 μm) were stacked in this order from an inner side.

Lastly, the electrolytic solution was injected into the outer package film 10 having the pouch shape and thereafter, the outer edge parts of the remaining one side of the outer package film 10 (the fusion-bonding layer) were thermal-fusion-bonded to each other in a reduced-pressure environment. In this case, the sealing film 41 (a polypropylene film having a thickness of 5 μm) was interposed between the outer package film 10 and the positive electrode lead 31, and the sealing film 42 (a polypropylene film having a thickness of 5 μm) was interposed between the outer package film 10 and the negative electrode lead 32. In this manner, the wound body was impregnated with the electrolytic solution, and the wound body was sealed inside the outer package film 10 having the pouch shape. The secondary battery was thus assembled.

### (Stabilization of Secondary Battery)

The assembled secondary battery was charged in an environment of a predetermined temperature (environmental temperature (° C.)), following which the charged secondary battery was stored for a predetermined period (storage period (hours)). Upon the charging, the secondary battery was charged with a constant current of 0.05 C until a voltage reached a predetermined voltage (upper limit voltage (V)). The upper limit voltage, the environmental temperature, and the storage period were each as listed in Tables 1 to 4. Note that 0.05 C was a value of a current that caused a battery capacity (a theoretical capacity) to be completely discharged in 20 hours.

In this manner, the film 21C was formed as described above, and the positive electrode 21 was thus fabricated. As a result, the battery device 20 was fabricated, and the state of the battery device 20 was electrochemically stabilized. The secondary battery was thus completed.

After the completion of the secondary battery, the secondary battery was disassembled to thereby collect the electrolytic solution. Thereafter, the electrolytic solution was analyzed by inductively coupled plasma (ICP) optical emission spectroscopy. As a result, a content (wt %) of the dinitrile compound in the electrolytic solution and a content (wt %) of the boron- and fluorine-containing lithium salt in the electrolytic solution were as listed in Tables 1 to 4. Further, the electrolytic solution was analyzed by a similar method. As a result, a content of the unsaturated cyclic carbonic acid ester in the electrolytic solution was 6 wt %, and a content of the halogenated carbonic acid ester in the electrolytic solution was 0.5 wt %.

In the case of fabricating the secondary battery, the conditions in the case of performing the stabilization process on the secondary battery, or more specifically, the charging current, the environmental temperature, and the storage period were each changed to thereby vary the intensity ratio R as presented in Tables 1 to 4. [Evaluation of Battery Characteristic]

Evaluation of the secondary batteries for their battery characteristics (the battery capacity characteristic, the swelling characteristic, and the electric resistance characteristic) revealed the results presented in Tables 1 to 4.

### (Battery Capacity Characteristic)

The secondary battery was charged and discharged in an ambient temperature environment (at a temperature of 23° C.) to thereby measure a discharge capacity (mAh/g) that was an index for evaluating the battery capacity. Upon the charging, the secondary battery was charged with a constant current of 0.05 C until a voltage reached the upper limit voltage and was thereafter charged with a constant voltage of the upper limit voltage until a current reached 0.005 C. Upon the discharging, the secondary battery was discharged with a constant current of 0.5 C until the voltage reached 3.0 V. Note that 0.005 C was a value of a current that caused a battery capacity (theoretical capacity) to be completely discharged in 200 hours, and 0.5 C was a value of a current that caused the battery capacity (theoretical capacity) to be completely discharged in 2 hours.

### (Swelling Characteristic)

First, the secondary battery was charged in an ambient temperature environment (at a temperature of 23° C.), following which a thickness (pre-storage thickness) of the secondary battery was measured. Charging conditions were similar to the charging and discharging conditions in the case of evaluating the battery capacity characteristic.

Thereafter, the charged secondary battery was stored in a high-temperature environment (at a temperature of 85° C.) for a storage period of 8 hours, following which the thickness (a post-storage thickness) of the charged secondary battery was measured.

Lastly, a swelling rate that was an index for evaluating the swelling characteristic was calculated based on the following calculation expression: swelling rate (%)=[(post-storage thickness−pre-storage thickness)/pre-storage thickness]×100.

### (Electric Resistance Characteristic)

The charged secondary battery was stored in a high-temperature environment to evaluate the swelling characteristic, following which the electric resistance (mΩ) of the secondary battery was measured by electrochemical impedance spectroscopy (EIS). In this case, a state of charge (SOC) was 100%, a measurement temperature was 0° C., and a frequency was 1 kHz.

TABLE 1
Positive electrode active material (lithium-cobalt composite oxide): LiCoO₂

| | | | Boron- and fluorine- | | Stabilization process | | | | | | |
|---|---|---|---|---|---|---|---|---|---|---|---|
| | Dinitrile compound | | containing lithium salt | | Upper limit | Environmental | Storage | | Discharge | Swelling | Electric |
| | | Content | | Content | voltage | temperature | period | Intensity | capacity | rate | resistance |
| | Kind | (wt %) | Kind | (wt %) | (V) | (° C.) | (hours) | ratio R | (mAh/g) | (%) | (mΩ) |
| Example 1 | SN | 5 | LiBF₄ | 0.9 | 4.45 | 30 | 65 | 0.19 | 190 | 0.9 | 32.3 |
| Example 2 | SN | 5 | LiBF₄ | 0.9 | 4.45 | 45 | 24 | 0.58 | 190 | 2.3 | 33.1 |
| Example 3 | SN | 5 | LiBF₄ | 0.9 | 4.45 | 60 | 10 | 0.65 | 191 | 1.1 | 32.8 |
| Example 4 | SN | 5 | LiBF₄ | 0.9 | 4.45 | 75 | 5 | 1.00 | 189 | 4.6 | 32.4 |
| Example 5 | SN | 3 | LiBF₄ | 0.9 | 4.45 | 45 | 24 | 0.74 | 190 | 3.1 | 34.1 |
| Example 6 | SN | 10 | LiBF₄ | 0.9 | 4.45 | 45 | 24 | 0.2 | 190 | 0.8 | 32.4 |
| Example 7 | SN | 5 | LiBF₄ | 0.5 | 4.45 | 45 | 24 | 0.46 | 191 | 0.7 | 32.3 |
| Example 8 | SN | 5 | LiBF₄ | 1.3 | 4.45 | 45 | 24 | 0.82 | 191 | 3.2 | 34.6 |
| Example 9 | AN | 5 | LiBF₄ | 0.9 | 4.45 | 45 | 15 | 0.85 | 191 | 3.5 | 32.2 |

TABLE 2
Positive electrode active material (lithium-cobalt composite oxide): LiCoO₂

| | | | Boron- and fluorine- | | Stabilization process | | | | | | |
|---|---|---|---|---|---|---|---|---|---|---|---|
| | Dinitrile compound | | containing lithium salt | | Upper limit | Environmental | Storage | | Discharge | Swelling | Electric |
| | | Content | | Content | voltage | temperature | period | Intensity | capacity | rate | resistance |
| | Kind | (wt %) | Kind | (wt %) | (V) | (° C.) | (hours) | ratio R | (mAh/g) | (%) | (mΩ) |
| Example 10 | SN + AN | 5 + 2 | LiBF₄ | 0.8 | 4.45 | 45 | 24 | 0.34 | 190 | 1.3 | 33.5 |
| Example 11 | SN | 6 | LiBF₄ | 0.7 | 4.45 | 55 | 12 | 0.61 | 190 | 0.9 | 34.7 |
| Example 12 | SN + AN | 5 + 2 | LiBF₄ | 1.0 | 4.35 | 45 | 24 | 0.49 | 190 | 0.4 | 32.2 |
| Example 13 | SN + AN | 5 + 2 | LiBF₄ | 1.0 | 4.35 | 60 | 10 | 0.40 | 189 | 0.7 | 32.2 |
| Example 14 | SN + AN | 5 + 2 | LiBF₄ | 1.0 | 4.45 | 45 | 24 | 0.38 | 189 | 0.6 | 32.4 |
| Example 15 | SN + AN | 5 + 2 | LiBF₄ | 1.0 | 4.45 | 60 | 10 | 0.29 | 190 | 0.8 | 32.8 |
| Example 16 | SN | 10 | LiBF₄ | 0.5 | 4.45 | 45 | 48 | 0.19 | 190 | 0.8 | 32.5 |
| Example 17 | SN | 3 | LiBF₄ | 0.8 | 4.45 | 45 | 24 | 0.78 | 190 | 3.3 | 34.8 |
| Example 18 | SN + AN | 3 + 2 | LiBF₄ | 1.3 | 4.45 | 45 | 24 | 1.00 | 189 | 4.6 | 32.5 |
| Example 19 | SN + AN | 3 + 2 | LiBF₄ | 1.3 | 4.45 | 45 | 36 | 0.93 | 189 | 4.8 | 31.9 |

TABLE 3
Positive electrode active material (lithium-cobalt composite oxide): LiCoO₂

| | | | Boron- and fluorine- | | Stabilization process | | | | | | |
|---|---|---|---|---|---|---|---|---|---|---|---|
| | Dinitrile compound | | containing lithium salt | | Upper limit | Environmental | Storage | | Discharge | Swelling | Electric |
| | | Content | | Content | voltage | temperature | period | Intensity | capacity | rate | resistance |
| | Kind | (wt %) | Kind | (wt %) | (V) | (° C.) | (hours) | ratio R | (mAh/g) | (%) | (mΩ) |
| Comparative | SN | 5 | LiBF₄ | 0.9 | 4.45 | 23 | 30 | 0.12 | 183 | 17.2 | 39.6 |
| example 1 | | | | | | | | | | | |
| Comparative | SN | 5 | LiBF₄ | 0.9 | 4.45 | 75 | 20 | 1.10 | 190 | 40.9 | 38.4 |
| example 2 | | | | | | | | | | | |
| Comparative | SN | 7 | LiBF₄ | 0.5 | 4.45 | 23 | 24 | 0.14 | 184 | 10.7 | 38.9 |
| example 3 | | | | | | | | | | | |
| Comparative | SN | 6 | LiBF₄ | 0.7 | 4.45 | 35 | 10 | 0.14 | 184 | 10.6 | 38.9 |
| example 4 | | | | | | | | | | | |
| Comparative | SN | 3 | LiBF₄ | 0.5 | 4.35 | 23 | 168 | 0.13 | 184 | 16.3 | 41.2 |
| example 5 | | | | | | | | | | | |
| Comparative | SN | 10 | LiBF₄ | 0.3 | 4.45 | 55 | 2 | 0.17 | 186 | 14.0 | 41.6 |
| example 6 | | | | | | | | | | | |
| Comparative | SN | 1 | LiBF₄ | 1.0 | 4.45 | 23 | 168 | 1.21 | 190 | 41.4 | 38.2 |
| example 7 | | | | | | | | | | | |
| Comparative | AN | 3 | LiBF₄ | 0.9 | 4.45 | 45 | 24 | 1.10 | 189 | 41.1 | 38.1 |
| example 8 | | | | | | | | | | | |
| Comparative | SN + AN | 5 + 2 | LiBF₄ | 1.0 | 4.35 | 23 | 168 | 0.15 | 185 | 15.2 | 43.5 |
| example 9 | | | | | | | | | | | |
| Comparative | SN + AN | 5 + 2 | LiBF₄ | 1.0 | 4.45 | 45 | 3 | 0.14 | 181 | 16.3 | 44.2 |
| example 10 | | | | | | | | | | | |

TABLE 4
Positive electrode active material (lithium-cobalt composite oxide): LiCoO₂

| | | | Boron- and fluorine- | | Stabilization process | | | | | | |
|---|---|---|---|---|---|---|---|---|---|---|---|
| | Dinitrile compound | | containing lithium salt | | Upper limit | Environmental | Storage | | Discharge | Swelling | Electric |
| | | Content | | Content | voltage | temperature | period | Intensity | capacity | rate | resistance |
| | Kind | (wt %) | Kind | (wt %) | (V) | (° C.) | (hours) | ratio R | (mAh/g) | (%) | (mΩ) |
| Comparative | SN | 7 | — | — | 4.45 | 23 | 168 | 0.07 | 184 | 18.2 | 47.3 |
| example 11 | | | | | | | | | | | |
| Comparative | SN | 7 | — | — | 4.45 | 45 | 24 | 0.10 | 183 | 17.3 | 47.0 |
| example 12 | | | | | | | | | | | |
| Comparative | SN | 7 | — | — | 4.45 | 60 | 10 | 0.11 | 185 | 17.1 | 46.9 |
| example 13 | | | | | | | | | | | |
| Comparative | AN | 6 | — | — | 4.45 | 23 | 168 | 0.16 | 184 | 17.4 | 49.5 |
| example 14 | | | | | | | | | | | |
| Comparative | SUN | 7 | — | — | 4.45 | 23 | 168 | 0.05 | 182 | 19.5 | 53.2 |
| example 15 | | | | | | | | | | | |
| Comparative | SN + AN | 5 + 1 | — | — | 4.35 | 23 | 168 | 0.12 | 184 | 15.9 | 39.5 |
| example 16 | | | | | | | | | | | |
| Comparative | SN + AN | 5 + 1 | — | — | 4.45 | 23 | 168 | 0.13 | 184 | 17.6 | 42.3 |
| example 17 | | | | | | | | | | | |
| Comparative | SN + AN | 5 + 2 | — | — | 4.35 | 23 | 168 | 0.17 | 184 | 15.9 | 39.2 |
| example 18 | | | | | | | | | | | |

As indicated in Tables 1 to 4, in the secondary battery in which the positive electrode active material layer 21B of the positive electrode 21 included the lithium-cobalt composite oxide, the discharge capacity, the swelling rate, and the electric resistance each varied greatly depending on the intensity ratio R.

Specifically, in a case where the electrolytic solution included the dinitrile compound and the boron- and fluorine-containing lithium salt, but the intensity ratio R was out of the range from 0.19 to 1.00 both inclusive (Comparative examples 1 to 10), a high discharge capacity was obtained, but each of the swelling rate and the electric resistance increased.

Further, in a case where the electrolytic solution included the dinitrile compound, but did not include the boron- and fluorine-containing lithium salt (Comparative examples 11 to 18), the intensity ratio R was out of the range from 0.19 to 1.00 both inclusive. Thus, a high discharge capacity was obtained, but each of the swelling rate and the electric resistance increased.

In contrast, in a case where the electrolytic solution included the dinitrile compound and the boron- and fluorine-containing lithium salt, and the intensity ratio R was within the range from 0.19 to 1.00 both inclusive (Examples 1 to 19), a high discharge capacity was obtained, and each of the swelling rate and the electric resistance decreased.

In this case, particularly, even when the kind of each of the dinitrile compound and the boron- and fluorine-containing lithium salt was changed, a similar tendency was achieved. Accordingly, a high discharge capacity was obtained, and each of the swelling rate and the electric resistance decreased. Further, when the content of the dinitrile compound in the electrolytic solution was within the range from 3 wt % to 10 wt % both inclusive, and the content of the boron- and fluorine-containing lithium salt in the electrolytic solution was within the range from 0.5 wt % to 1.3 wt % both inclusive, the swelling rate and the electric resistance were each sufficiently decreased while the discharge capacity was secured.

Based upon the results presented in Tables 1 to 4, when the positive electrode 21 included the positive electrode active material layer 21B and the film 21C, the film 21C included cobalt, carbon, nitrogen, boron, and oxygen as constituent elements, and the intensity ratio R defined by the result of the negative ion analysis of the film 21C by TOF-SIMS was within the range from 0.19 to 1.00 both inclusive, all of the discharge capacity, the swelling rate, and the electric resistance improved. It was thus possible to achieve a superior battery capacity characteristic, a superior swelling characteristic, and a superior electric resistance characteristic.

Although the present technology has been described herein with reference to one or more embodiments including Examples, the configuration of the present technology is not limited thereto, and is therefore modifiable in a variety of suitable ways.

For example, the description has been given of the case where the secondary battery has a battery structure of the laminated-film type. However, the battery structure of the secondary battery is not particularly limited, and may thus be, for example, a cylindrical type, a prismatic type, a coin type, or a button type.

Further, the description has been given of the case where the battery device has a device structure of a wound type. However, the device structure of the battery device is not particularly limited, and may thus be, for example, a stacked type or a zigzag folded type. In the stacked type, the positive electrode and the negative electrode are stacked on each other. In the zigzag folded type, the positive electrode and the negative electrode are folded in a zigzag manner.

Further, although the description has been given of the case where the electrode reactant is lithium, the electrode reactant is not particularly limited. For example, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode; and
an electrolytic solution, wherein
the positive electrode includes a positive electrode active material layer and a film, the film covering a surface of the positive electrode active material layer,
the film includes cobalt, carbon, nitrogen, boron, and oxygen,
a first peak derived from CoC₂N₂⁻ and a second peak derived from BOₓ⁻ are detectable based on a negative ion analysis of the film by time-of-flight secondary ion mass spectrometry, and
a ratio of an intensity of the second peak to an intensity of the first peak is greater than or equal to 0.19 and less than or equal to 1.00.

2. The secondary battery according to claim 1, wherein the electrolytic solution includes a dinitrile compound and a boron- and fluorine-containing lithium salt.

3. The secondary battery according to claim 2, wherein
the dinitrile compound includes succinonitrile, adiponitrile, or both, and
the boron- and fluorine-containing lithium salt includes lithium tetrafluoroborate.

4. The secondary battery according to claim 2, wherein
a content of the dinitrile compound in the electrolytic solution is greater than or equal to 3 weight percent and less than or equal to 10 weight percent, and
a content of the boron- and fluorine-containing lithium salt in the electrolytic solution is greater than or equal to 0.5 weight percent and less than or equal to 1.3 weight percent.

5. The secondary battery according to claim 1, wherein the positive electrode active material layer includes a lithium-cobalt composite oxide represented by Formula (1),
LiₓCO_{y}M_{1-y}O₂ (1)
where
M is at least one of Ni, Mn, Mg, Al, B, Ti, V, Cr, Fe, Cu, Zn, Mo, Sn, Ca, Sr, or W, and
x and y satisfy 0.8≤x≤1.2 and 0.5≤y≤1.

6. The secondary battery according to claim 1, further comprising an outer package member having flexibility and containing the positive electrode, the negative electrode, and the electrolytic solution.

7. The secondary battery according to claim 1, wherein the secondary battery comprises a lithium-ion secondary battery.
